(19) United States
(12) Patent Application Publication
(10) Pub. No.: US 2026/0034808 A1
(43) Pub. Date: Feb. 5, 2026

(54) PRINTING APPARATUS

(71) Applicant: CANON KABUSHIKI KAISHA, Tokyo (JP)

(72) Inventors: KEITA TAMIYA, Kanagawa (JP); CHIHIRO NAGURA, Tochigi (JP); KAZUYA TSUJINO, Tokyo (JP)

(21) Appl. No.: 19/286,450

(22) Filed: Jul. 31, 2025

(30) Foreign Application Priority Data
Aug. 2, 2024 (JP) 2024-128079

(51) Int. Cl. B41J 11/00; G01S 17/88

(52) U.S. Cl. CPC B41J 11/0095; G01S 17/88

(57) ABSTRACT

A printing apparatus has a sensor unit including a light emitter, a plurality of light sensitive units that detect reflected light of light emitted from the light emitter, and an aperture member provided between the plurality of light sensitive units and a detection target that includes an opening for limiting input of the reflected light to a light sensitive unit. The printing apparatus causes the sensor unit to scan relative to the detection target, and, based on a differential signal of signals from a first light sensitive unit and a second light sensitive unit, detects an edge of a printing medium in the detection target. The plurality of light sensitive units are arranged to be aligned in a scanning direction, and the first and second light sensitive units detect the reflected light through the same opening of the aperture member.

### BACKGROUND

### Field of the Technology

The present disclosure relates to a printing apparatus.

### Description of the Related Art

When performing marginless printing with an inkjet printing apparatus, if the accuracy in detecting an edge portion of a printing medium such as a sheet is poor, it leads to problems such as staining in the apparatus and generation of a unintended margin at an edge of the printing medium. A general method of detecting an edge portion of a printing medium (hereinafter, a medium edge portion) in such a printing apparatus is as follows. A light emitting device, such as an LED, and a light sensitive device that converts an optical signal into an electric signal, such as a phototransistor, are used, and reflected light, which is light emitted from the light emitting device and reflected by the printing medium, is detected by the light sensitive device, and a medium edge portion is detected based on the detected signal. Detection accuracy of this detection technique tends to decrease due to environmental variations such as staining on the printing medium.

Japanese Patent Laid-Open No. H16-182361 discloses, in an image forming apparatus that includes a media sensor having a light emitting device and a light sensitive device, detecting a medium edge portion based on a detection signal of the light sensitive device when a detection target position of a media sensor relative to a sheet is moved. Specifically, a configuration in which a value of current to be supplied to the light emitting device for each position on the sheet is obtained to thereby obtain a current value for detecting a paper edge, and the influence of environmental variations is reduced to accurately detect the medium edge portion is described.

Japanese Patent Laid-Open No. H16-182361 discloses a method of detecting a medium edge portion using one light emitting device and one light sensitive device. In a case where one light emitting device and one light sensitive device are thus used, a detection voltage that crosses a threshold is generated due to environmental variations that occur during scanning a printing medium, such as lifting of an edge of the printing medium or external light, for example. Therefore, there is a problem that the influence of environmental variations cannot be reduced, and that the medium edge portion cannot be detected with high accuracy.

### SUMMARY

Embodiments of the present disclosure eliminate the above-mentioned issues with conventional technology.

A feature of embodiments of the present disclosure is to provide a technique for reducing the influence of environmental variations to detect a medium edge portion with high accuracy.

According to embodiments of the present disclosure, there is provided a printing apparatus comprising: a sensor unit that includes a light emitter configured to emit light toward a detection target, a plurality of light sensitive units that include a first light sensitive unit and a second light sensitive unit configured to detect reflected light of the light, and an aperture member that is provided between the plurality of light sensitive units and the detection target and includes an opening configured to limit input of reflected light to a light sensitive unit; and one or more controllers including one or more processors and one or more memories, wherein the one or more controllers are configured to: cause the sensor unit to scan relative to the detection target; and based on a differential signal obtained by differentially amplifying signals from the first light sensitive unit and the second light sensitive unit, detect an edge of a printing medium included in the detection target, wherein the plurality of light sensitive units are arranged to be aligned in a scanning direction of the scan, and the first light sensitive unit and the second light sensitive unit detect the reflected light through the same opening of the aperture member.

Further features of the various embodiments will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a block diagram for describing a configuration of an inkjet printing apparatus according to an embodiment of the present disclosure.

FIG. 2 is a schematic diagram illustrating a mechanism when a carriage mounted with a print head of the inkjet printing apparatus according to the embodiment is viewed from above.

FIG. 3 is a conceptual diagram for describing the operation of a sensor unit according to the embodiment.

FIG. 4 is a diagram for describing details of the operation of the sensor unit when detecting an edge portion of a sheet.

FIGS. 5A and 5B are diagrams for explaining an example of selection of light sensitive devices in a light sensitive device array.

FIGS. 6A and 6B are diagrams for explaining the influence of the diameter of a light receiving aperture on detection regions.

FIGS. 7A and 7B are diagrams illustrating an example of the shape of an aperture of an aperture member.

FIG. 8 is a diagram illustrating an example of connection of a differential amplifier, a selector, and a light sensitive device array of the sensor unit according to the embodiment.

FIG. 9 is a flowchart for explaining edge detection processing using the sensor unit according to the embodiment.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

First, the terms used in the present embodiment will be defined in advance as follows.

### “Printing”

In this specification, “printing” is not only forming significant information such as letters, shapes, and the like. The significance or insignificance is irrelevant, as is whether visual perception by humans is possible. It refers to forming images, designs, patterns, and the like broadly on a printing medium, as well as processing the medium.

### “Printing Media”

Printing media refers not only to paper used in general printing apparatuses, but also broadly to those that can receive ink, such as cloth, plastic films, metal plates, glass, ceramics, wood, and leather.

### “Ink”

Ink is to be interpreted broadly, similar to the definition of “printing” above, and refers to a medium that includes a printing agent which, by being applied to a printing medium, forms images, designs, patterns, and the like, or which may be supplied in processing of a printing medium, or processing of ink. In terms of physical properties, it is a liquid. The above ink processing is, for example, coagulation or insolubilization of a colorant in an ink applied to a printing medium.

### “Nozzle”

Unless otherwise specified, “nozzle” refers to a discharge port. Inside the nozzle, there are communicating liquid paths and an element that generates energy used for ink discharge.

### “Scanning”

In order to perform printing on a printing medium, a print head scans over the printing medium and performs printing. Here, the movement of the head during acceleration and deceleration of the head for or related to printing is referred to as scanning.

### “Reciprocal Printing”

Reciprocal printing refers to performing printing while performing a reciprocal operation of the above “printing” or “scanning” over the paper surface. Reciprocal scanning, reciprocal printing, bidirectional scanning, and bidirectional printing also refer to similar things.

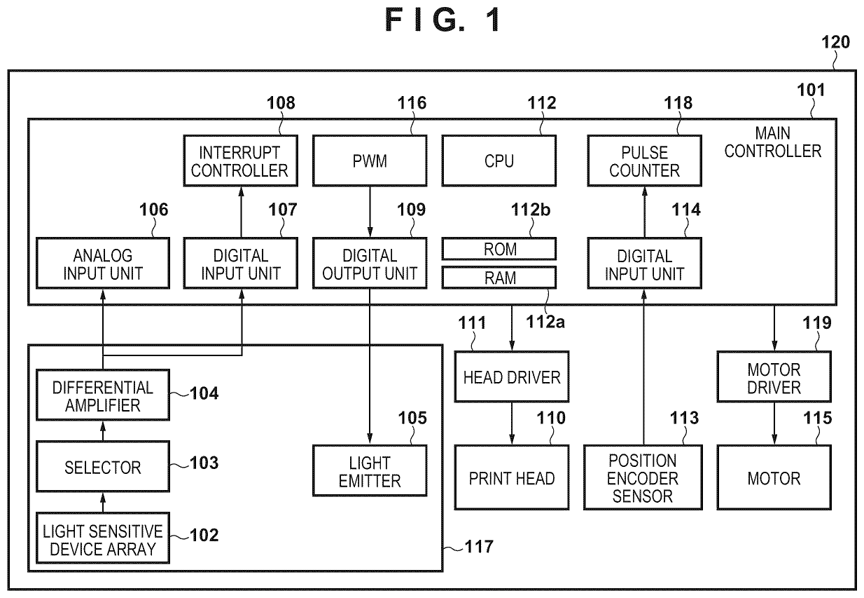

FIG. 1 is a block diagram for describing a configuration of an inkjet printing apparatus 120 according to an embodiment of the present disclosure.

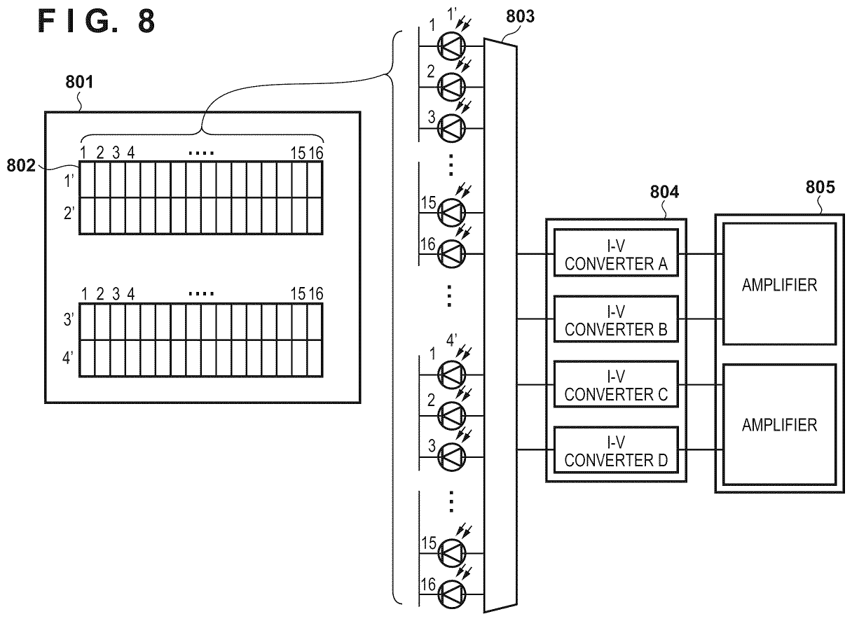

A sensor unit 117 includes a light emitter 105 and a light sensitive device array 102, and signals outputted from the light sensitive device array 102 are outputted to a differential amplifier 104 via a selector 103. The differential amplifier 104 can amplify or differentially amplify the signals from the selected light sensitive devices (light sensitive sensors) in the light sensitive device array 102 according to the settings of the selector 103, and sends the amplified signal to a main controller 101. An example of a circuit of the sensor unit 117 will be described later with reference to FIG. 8. The main controller 101 receives the signal from the differential amplifier 104 at an analog input unit 106 and a digital input unit 107. An output of the digital input unit 107 is connected to an interrupt controller 108 in the main controller 101, and the interrupt controller 108 issues an interrupt signal to a CPU 112 according to a predetermined interrupt condition, such as the output of the digital input unit 107. The CPU 112 is responsible for control by the main controller 101, and controls the operation of the inkjet printing apparatus 120 by executing a program stored in a ROM 112b. Further, a RAM 112a provides a work area of the CPU 112, and is used to temporarily store various kinds of data at the time of control by the CPU 112. Upon receiving the interrupt signal, the CPU 112 executes the processing of the interrupt signal with priority over the processing being performed, and can thus handle the signal inputted to the digital input unit 107 more immediately. The light emitter 105 is driven by a pulse width modulation signal, which is outputted from a pulse width modulation (PWM) unit 116 in the main controller 101 via a digital output unit 109, and its light emission amount is controlled by pulse width modulation.

The main controller 101 drives a print head 110 via a head driver 111 according to an image signal to be printed, and drives a motor 115 via a motor driver 119 to scan the print head 110 or to convey the printing medium. The print head 110 performs printing on a printing medium by scanning over the printing medium by being driven by the motor 115 under the control of the main controller 101. A scanning position of the print head 110 is detected based on a signal from a position encoder sensor 113, which is inputted to a digital input unit 114, and that scanning position is managed by a pulse counter 118 in the main controller 101.

FIG. 8 is a diagram illustrating an example of connection of the differential amplifier, the selector, and the light sensitive device array of the sensor unit 117 according to the embodiment.

A light sensitive device array 801, which is constituted by a plurality of sensors and corresponds to the light sensitive device array 102, is arranged in the sensor unit 117. FIG. 8 illustrates a sensor unit that includes a total of 64 sensors, with light sensitive devices 802 in a 16×4-row arrangement. Each light sensitive device 802 is connected to a selector 803 in the sensor unit 117. The selector 803 corresponds to the selector 103 of FIG. 1. A light sensitive device 802 to be used to detect a medium edge portion can be arbitrarily selected from the light sensitive device array 801 according to the settings of the selector 803. Further, the outputs of a plurality of light sensitive devices 802 can be bundled and output according to the settings of the selector 803, and the number of light sensitive devices 802 to be bundled and the positions of the light sensitive devices 802 can also be arbitrarily selected. For example, the outputs of 16 light sensitive devices from the first to 16th ones of the third row can be connected to the selector 803 in a bundle as a light sensitive unit, or the outputs of odd-numbered light sensitive devices, such as the first, third, fifth, and seventh ones of the first row, can be selected as the light sensitive unit. Furthermore, the light sensitive unit can be selected with arbitrary positions and number of light sensitive devices to be selected, such as selecting the outputs of the first light sensitive device 802 of each row from 1′ to 4′ as the light sensitive unit. By thus allowing selection of a plurality of bundled light sensitive devices 802 as the light sensitive unit, it is possible to artificially increase the surface area of the light sensitive unit, allowing realization of an increase in sensitivity of the light sensitive unit, for example. The settings of the selector 803 can be switched by an instruction from the CPU 112, and selection, arrangement, and the like of light sensitive devices, which will be described later, are performed by cooperation of the CPU 112 and the selector 103.

The outputs of the selector 803 are connected to I-V (current to voltage) converters A to D arranged in an I-V converter 804 in the sensor unit 117. This makes it possible to arbitrarily select by the selector 803 which I-V converter to connect the output of a light sensitive device 802 or a group of a plurality of light sensitive devices 802 to. The outputs of the I-V converter 804 are connected to an amplifier unit 805, and an amplified output can be obtained from the amplifier unit 805. The amplifier unit 805 corresponds to the differential amplifier 104 of FIG. 1. The amplifier unit 805 includes a coarse-tuning amplifier, a fine-tuning amplifier, a differential amplifier, and the like, and which amplifier to use can be arbitrarily selected, and a combination of respective amplifiers can be arbitrarily selected. However, the configuration of the amplifier unit 805 is not limited to only what has been described above, such as arranging one type of amplifier or arranging more types of amplifiers, in addition to the case where a plurality of amplifiers are arranged in the amplifier unit 805.

Further, in FIG. 8, the selector 803, the I-V converter 804, and the amplifier unit 805 are incorporated in the sensor unit 117. However, the sensor unit 117 may include only the light sensitive device array 801, and the selector 803, the I-V converter 804, and the amplifier unit 805 may be configured as an external circuit. As an example of a combination at the time of detecting the medium edge portion, for example, the outputs of the first light sensitive devices 802 on the row l′ and on the row 2′ of the light sensitive device array 801 are selected by the selector 803, and are connected to the I-V converter A and the I-V converter B of the I-V converter 804, respectively. Then, these outputs of the I-V converter A and the I-V converter B are inputted to a differential amplifier of the amplifier unit 805, and an operation for detecting the medium edge portion, which will be described later, can be performed according to an output obtained from the amplifier unit 805. By thus allowing arbitrary selection of the positions and number of light sensitive devices 802 to be used to detect the medium edge portion, when detecting the medium edge portion, detection can be performed in anticipation of various cases.

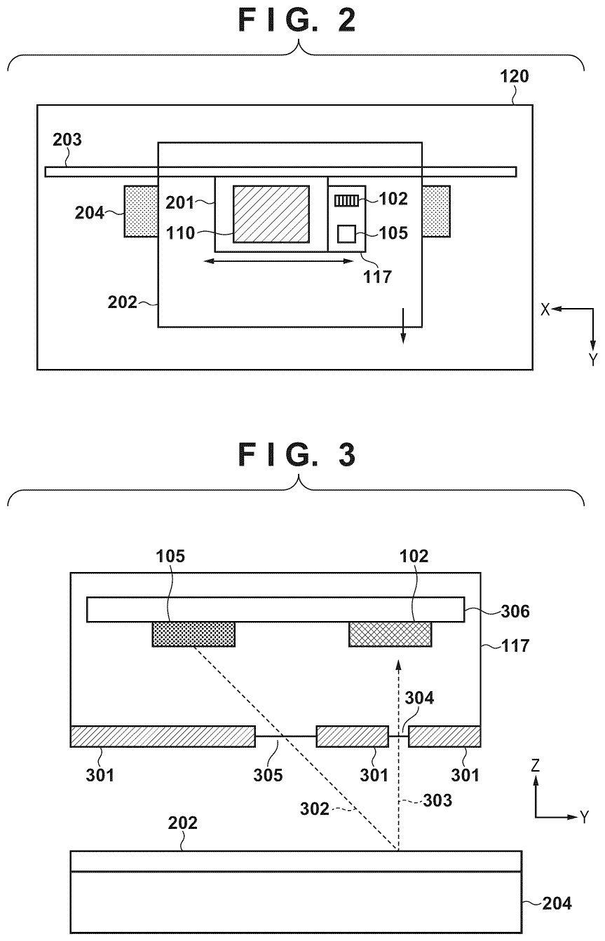

FIG. 2 is a schematic diagram illustrating a mechanism when a carriage 201 mounted with the print head 110 of the inkjet printing apparatus 120 according to the embodiment is viewed from above.

The print head 110 is mounted on the carriage 201, and the carriage 201 is supported so as to be capable of reciprocal scanning along a main rail 203. The sensor unit 117 is also mounted on the carriage 201, and is also capable of reciprocal scanning. Further, the CPU 112 can obtain the scanning position of the sensor unit 117 by the above pulse counter 118. The sensor unit 117 is capable of scanning in a width direction (X direction) of a sheet 202, and the main controller 101 can perform an operation for detecting the medium edge portion based on light reflected by the sheet 202, a platen 204, and the like. The sheet 202 is supported on the platen 204. The light sensitive device array 102 (light sensitive device array 801 of FIG. 8) of the sensor unit 117 is arranged in parallel to a scanning direction (X direction) of the carriage 201. The light emitter 105 is arranged at a position shifted in a vertical direction (Y direction) with respect to the light sensitive device array 102. With such an arrangement, it is possible to reduce the width of the carriage 201, which includes the sensor unit 117.

FIG. 3 is a conceptual diagram for describing the operation of the sensor unit 117 according to the embodiment.

FIG. 3 depicts a view of the sensor unit 117 from a side, and respective light sensitive devices of the light sensitive device array 102 are arranged in a depth direction (X direction) of the figure. The light emitter 105 and the light sensitive device array 102 on a substrate 306 face the sheet 202 or the platen 204 via an aperture member 301 of the sensor unit 117. The light emitted from the light emitter 105 is projected onto the sheet 202 as a light beam 302 through a light emitting aperture 305. The light beam 302 is reflected by the sheet 202, and a part thereof is received by the light sensitive device array 102 as a light beam 303 through a light receiving aperture (opening) 304. At this time, regarding the light beam 303, diffuse reflection from the sheet 202 is utilized, and a reflection component with low dependence on the reflection angle is utilized.

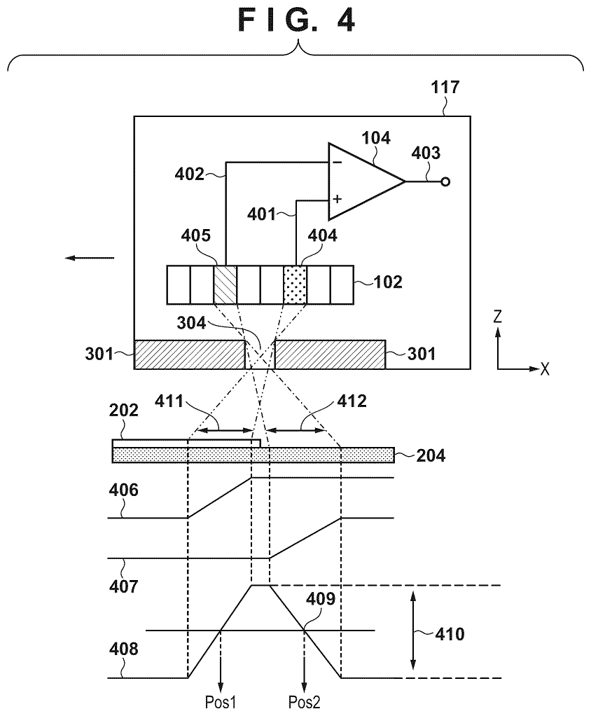

FIG. 4 is a diagram for describing details of the operation of the sensor unit 117 when detecting an edge portion of the sheet 202.

The outputs of light sensitive devices 404 and 405 of the light sensitive device array 102 are selected by the selector 103 and connected to the differential amplifier 104, and a signal 401, which is outputted from the light sensitive device 404, and a signal 402, which is outputted from the light sensitive device 405, are inputted to the differential amplifier 104. Here, the signal 401 is inputted to a non-inverting input terminal (+) of the differential amplifier 104, and the signal 402 is inputted to an inverting input terminal (−) of the differential amplifier 104. With this, the differential amplifier 104 outputs a differential signal 403 based on a difference between the inputted signals 401 and 402.

Although the light emitter 105 is not illustrated in FIG. 4, light is irradiated from a near-side or far-side direction of FIG. 4 toward the sheet 202 through the light emitting aperture of the aperture member 301. The light sensitive devices 404 and 405 detect light reflected by the sheet 202 through the light receiving aperture 304 of the aperture member 301. Since the light sensitive devices 404 and 405 each have an angle with respect to the light receiving aperture 304, the light sensitive device 404 assumes a region 411 as a detection region and the light sensitive device 405 assumes a region 412 as a detection region.

Next, regarding the movement of signals, it is assumed that the carriage 201 and the sensor unit 117 are moved in the left direction (arrow direction) from the right side of the figure. When the sensor unit 117 moves above an edge of the sheet 202, since the detection region 411 reaches the sheet 202 first, the light sensitive device 404 will detect light reflected by the sheet 202 first, and the level of the signal 401, which is outputted from the light sensitive device 404, increases as shown as a detection waveform 406 and is inputted to the non-inverting input terminal (+) of the differential amplifier 104. The detection waveform 406 is a temporal illustration of the signal 401.

Here, regarding with the detection region 411 which is detected by the light sensitive device 404, when the sensor unit 117 is positioned further to the right than illustrated in FIG. 4, the detection region 411 is over the platen 204, which has a low reflectance. Therefore, a small amount of reflected light enters the light sensitive device 404, and the detection waveform 406 is at a low level. Next, when the sensor unit 117 moves in the left direction (arrow direction) in FIG. 4, the detection region 411 detects the sheet 202, which has a high reflectance, as illustrated in FIG. 4, and the detection waveform 406 transitions to a high level. At this time, since the detection region 412 of the light sensitive device 405 is still above the platen 204, the level of the signal 402 outputted by the light sensitive device 405 remains low. Therefore, a level difference occurs between the signal 401 and the signal 402, and when the detection region 412 is above the platen 204, and the detection region 411 above the sheet 202 increases, the differential signal 403 outputted from the differential amplifier 104 becomes more higher level signal.

When the carriage 201 further moves in the arrow direction from here, the sheet 202 reaches the detection region 412 of the light sensitive device 405, and the sheet 202 thus starts to be detected by the light sensitive device 405. With this, the signal 402 outputted from the light sensitive device 405 also transitions to a higher level as illustrated by a detection waveform 407. When the level of the signal 402 thus increases, the difference with the level of the signal 401, which is already at a high level, decreases, and the differential signal 403 outputted from the differential amplifier 104 starts to decrease. Accordingly, the waveform of the differential signal 403 will be as illustrated by a differential waveform 408 and becomes a detection signal that is pulse-shaped around an edge of the sheet 202.

The rise and fall timings are obtained according to a threshold 409 relative to the pulse-shaped detection signal. That is, the scanning positions (position coordinates) of the carriage 201 at respective timings for when the detection signal becomes the threshold or above and when the detection signal becomes the threshold or less are obtained as Pos1 and Pos2, respectively. By taking the center coordinates of the position coordinates Pos1 and Pos2, the main controller 101 can detect an edge portion of the sheet 202 that is positioned in the center of the light sensitive devices 404 and 405 in arrangement. The edge portion is not limited to the center coordinates of Pos1 and Pos2, and for example, may be obtained as a position corresponding to a ratio set in advance, such as a position obtained by dividing a distance between Pos1 and Pos2 in a 6:4 ratio, for example.

An advantage is that by thus detecting an edge of a sheet based on differential detection in which a difference between two signals is taken, it is possible to cancel out the influence of disturbance that each of the light sensitive devices 404 and 405 receives in common, and stably detect the medium edge portion.

To take advantage of differential signal-based edge portion detection, it is necessary that signals from which a differential is taken be symmetrical in optics and circuits, and to avoid an overlap between the signals from which the differential is taken. Without symmetry, the timings of the signal levels of the signals 401 and 402 outputted by the light sensitive devices 404 and 405 will be shifted, and when a difference is taken by the differential amplifier 104, the shift is left without being cancelled out. As a result, an amplitude 410 of the differential waveform 408 outputted from the differential amplifier 104 decreases, or a signal offset occurs, causing the signal-to-noise ratio of the differential signal to decrease. Further, if the signals from which a differential is taken overlap, when the differential is taken by the differential amplifier 104, the overlapping portion will be canceled out, resulting in a loss of signal strengths of the original detection waveforms 406 and 407. Accordingly, problems such as a decrease in the amplitude 410 also arise.

To avoid such problems, the light sensitive devices 404 and 405 for taking a differential are selected from among the light sensitive device array 102. In general, semiconductors have large variations in characteristics, and when light sensitive devices are constituted by individual semiconductor devices, their sensitivities vary greatly. Meanwhile, the light sensitive device array 102 is manufactured using a method of forming a circuit by lithography on a wafer made of the same semiconductor material. Therefore, variations in the semiconductor material among the light sensitive devices in the light sensitive device array 102 are also small, and dimensional variations among respective light sensitive devices can also be reduced by the accuracy of lithography. Therefore, it is possible to reduce the sensitivity variation among light sensitive devices. When, instead of taking such a configuration, each light sensitive unit is configured using individual semiconductors or the like, it is necessary to provide, before the differential amplifier 104, an amplifier for electrically adjusting outputs and offsets in order to reduce the sensitivity variation of the light sensitive units, which leads to cost and surface area increase.

Further, by selecting light sensitive devices in the light sensitive device array 102 and using them to detect an edge portion, it is possible to manage the positional relationship among light sensitive devices with high accuracy. Further, regarding the positions of electronic components on a substrate, variations or the like in the mount positions of components occur during solder mounting processing, and depending on the positional relationship between light sensitive devices, and light emitting devices and the aperture, it may lead to variations in characteristics between light sensitive devices. Meanwhile, when selecting and using light sensitive devices in the light sensitive device array, it is possible to manage the characteristics, position, and the like of each light sensitive device with high accuracy of the semiconductor process, and so, it is possible to reduce the influence of variations or the like in positions among light sensitive devices. In addition, even when, instead of the light sensitive device array, the light sensitive devices are in the same package, the position management of the light sensitive devices can be improved as compared with the case where individual light sensitive devices are arranged.

Regarding the arrangement of the optical system, as previously described in FIG. 2, the light emitter 105 is arranged to be apart in a direction (Y direction) perpendicular to an arrangement direction of the light sensitive device array 102, and is arranged at the same position in the X direction. This makes it possible to make a distance between each light sensitive device in the light sensitive device array 102 and the light emitter 105 substantially equal. Therefore, an imbalance in the light amount distribution depending on the distance from the light emitter 105 to each light sensitive device can be reduced, and the symmetry among respective light sensitive devices can be increased.

In FIG. 4, the light sensitive device 404 forms the detection region 411 on the detection surface through the light receiving aperture 304, and similarly, the light sensitive device 405 forms the detection region 412 through the same light receiving aperture 304. These detection regions mainly spread like the light beams illustrated in FIG. 4, but the spread is determined by the size and diameter of the light receiving aperture 304, the distance from the light sensitive device, the distance to the detection target (which includes at least one of the sheet 202 and the platen 204), and the like. Further, by sharing one aperture to have the same shape of aperture, the respective light sensitive devices can obtain highly symmetrical detection regions.

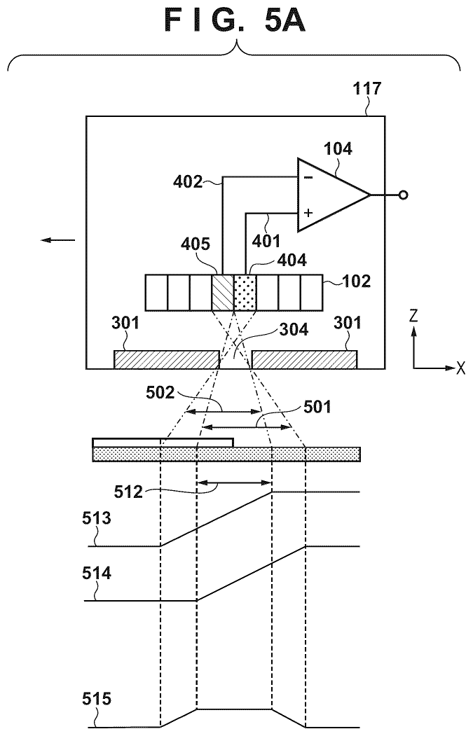

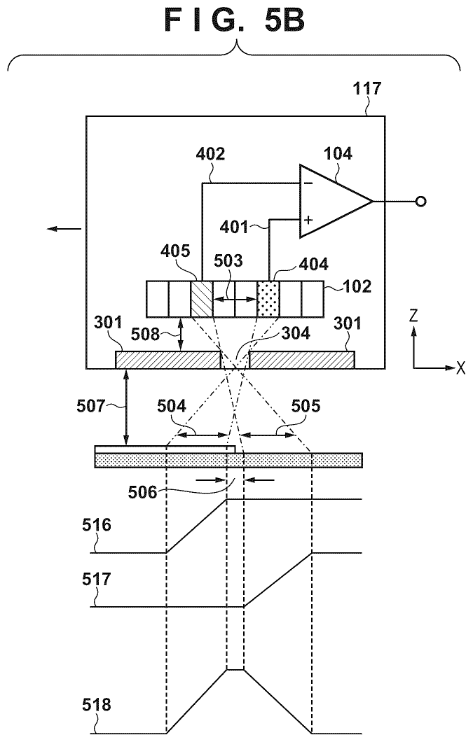

FIGS. 5A and 5B are diagrams for explaining an example of selection of light sensitive devices in the light sensitive device array 102.

FIG. 5A illustrates a case where the neighboring light sensitive devices 404 and 405 are selected in the light sensitive device array 102. In this case, detection region 501 and 502 formed by the respective light sensitive devices 404 and 405 through the light receiving aperture 304 overlap in a section of a region 512. This causes the amplitude of the differential signal obtained from the signals outputted from the light sensitive devices 404 and 405 to decrease. A detection waveform 513 denotes the waveform of the signal 401 outputted from the light sensitive device 404, and a detection waveform 514 denotes the waveform of the signal 402 outputted from the light sensitive device 405. Then, the waveform of the differential signal outputted by the differential amplifier 104 at this time is as indicated by a differential waveform 515 in FIG. 5A. Accordingly, the amplitude of the differential signal obtained from the signals outputted from the light sensitive devices 404 and 405 decreases.

In contrast, FIG. 5B illustrates a case where the light sensitive devices 404 and 405, which are positioned apart by a predetermined amount, are selected in the light sensitive device array 102. Here, an invalid device region 503, which includes a predetermined number of light sensitive devices, is provided between the selected light sensitive devices 404 and 405. This can increase the distance between the detection region 504 and 505 and thus separate the detection regions 504 and 505, and makes it possible to avoid an overlap of detection regions. A detection waveform 516 indicates the waveform of the signal 401 outputted from the light sensitive device 404, and a detection waveform 517 indicates the waveform of the signal 402 outputted from the light sensitive device 405, and a differential waveform 518 indicates a differential signal outputted from the differential amplifier 104 at this time.

The number and width of light sensitive devices of the invalid device region 503 are defined such that the detection regions 504 and 505 formed by the light sensitive devices 404 and 405 through the light receiving aperture 304 do not overlap, or an overlap width is small. Alternatively, it may be defined so as to ensure a region 506 with a width of a non-overlapping range. The respective detection regions 504 and 505 can be geometrically determined from the width between the light sensitive devices 404 and 405, a distance 508 from the light sensitive device to the top surface of the aperture member 301, an opening width of the light receiving aperture 304, a distance 507 from the light receiving surface side of the aperture member 301 to the detection target surface. In addition, if there is an influence of reflection in the unit (not illustrated), adjustments such as widening the width of the invalid device region 503 can be made.

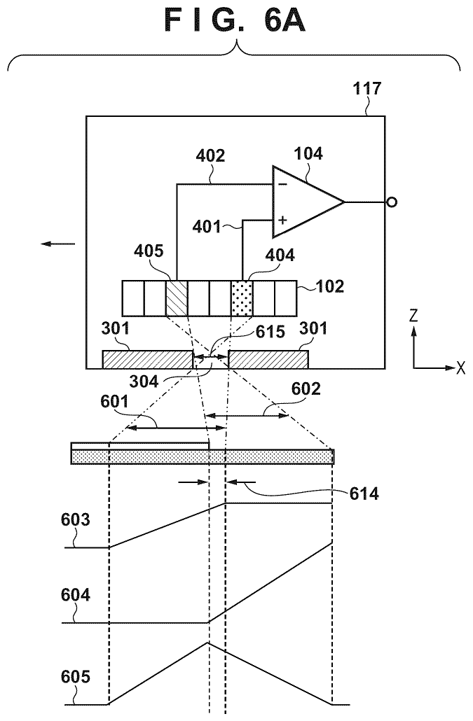

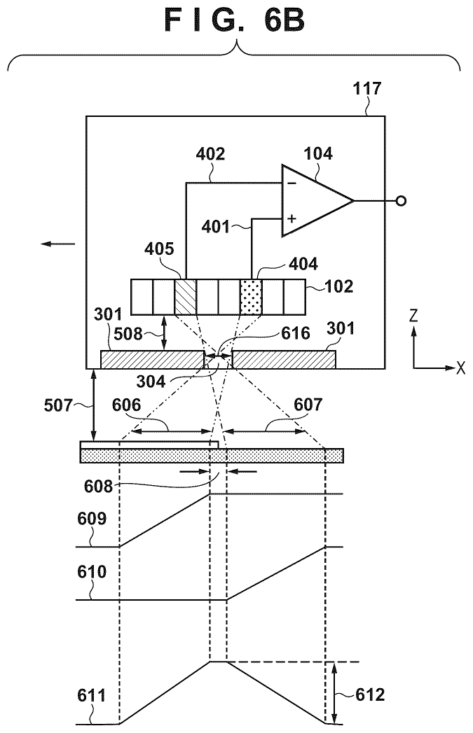

FIGS. 6A and 6B are diagrams for explaining the influence of the diameter of the light receiving aperture 304 on detection regions.

FIG. 6A illustrates a case where the diameter of the light receiving aperture 304 is greater than a predetermined amount, as indicated by reference numeral 615. The detection regions of the light sensitive devices 404 and 405 formed through the light receiving aperture 304 spreads in the scanning direction of the carriage 201 as illustrated by detection region 601 and 602. This causes the waveforms of the detection signals 401 and 402 outputted from the respective light sensitive devices 404 and 405 to increase in respective transition ranges, as indicated by detection waveforms 603 and 604, and an overlap width 614 to arise. With this, the waveform of the differential signal outputted from the differential amplifier 104 becomes as indicated by a differential waveform 605. Here, the level of the detection waveform 604 begins to rise before the level of the preceding detection waveform 603 reaches its highest point and thus cancels an increase in the level of the differential signal. With this, a maximum amplitude cannot be obtained, as indicated by the differential waveform 605, and the signal level begins to decrease. In such a case, a valid differential signal cannot be obtained from the detection signals obtained from the overlapping detection regions 601 and 602.

FIG. 6B illustrates a case where the diameter of the light receiving aperture 304 is smaller than the example of FIG. 6A, as indicated by reference numeral 616.

By making the light receiving aperture 304 small like the diameter 616, detection regions 606 and 607 formed by the light sensitive devices 404 and 405 through the light receiving aperture 304 do not overlap, and spacing 608 is formed, or the overlap width 614 of FIG. 6A becomes narrow. The respective detection regions 606 and 607 can be geometrically determined from spacing between the light sensitive devices 404 and 405, the distance 508 from the light sensitive device to the top surface of the aperture member 301, the opening width of the light receiving aperture 304, the distance 507 from the light receiving surface side of the aperture member 301 to the detection target surface. In addition, if there is an influence of reflection in the unit (not illustrated), adjustments such as narrowing the diameter 616 of the light receiving aperture 304 can be made. A detection waveform 609 denotes the waveform of the signal 401 outputted from the light sensitive device 404, and a detection waveform 610 denotes the waveform of the signal 402 outputted from the light sensitive device 405, and a differential waveform 611 indicates the waveform of a differential signal outputted from the differential amplifier 104 at this time. As illustrated by an amplitude 612, the differential waveform 611 has a sufficient amplitude based on which the scanning position of the carriage 201 can be obtained by comparison with the threshold.

Even in the case of FIG. 6A, by moving the respective positions of the light sensitive devices 404 and 405 selected by the light sensitive device array 102 toward the end directions of the light sensitive device array 102 in directions opposite to each other, the detection regions 601 and 602 can be made to not overlap. That is, by widening the spacing between the light sensitive devices 404 and 405, the detection regions 601 and 602 can be made to not overlap.

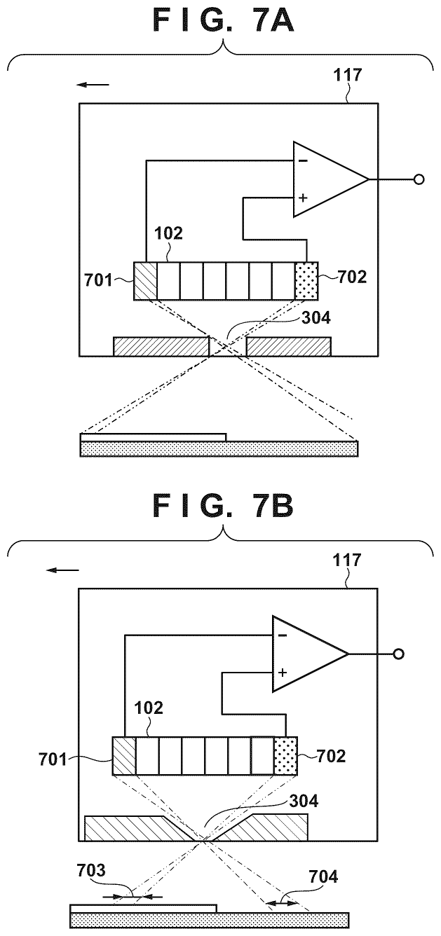

FIGS. 7A and 7B are diagrams illustrating an example of the shape of the aperture of the aperture member.

FIG. 7A illustrates a cases where the diameter of the light receiving aperture 304 is reduced and light sensitive devices 701 and 702 positioned on the outer sides (both ends) of the light sensitive device array 102 are used. As in FIG. 7A, since the angles of light beams to be inputted to the light sensitive devices 701 and 702 through the light receiving aperture 304 are sharp, the light that can be taken in from the detection target surface becomes too weak.

In contrast, FIG. 7B illustrates an example of a case where the surface of the light receiving aperture 304 is reverse tapered, which opens to the light sensitive device side. That is, the detection surface side of the light receiving aperture 304 has a small diameter, and the light sensitive device array side is widened. This makes it possible to, even when using the light sensitive devices 701 and 702 positioned on the outer sides (both ends) of the light sensitive device array 102, ensure detection regions 703 and 704. That is, by making the surface of the light receiving aperture 304 as in FIG. 7B, it becomes possible to widen the range of light sensitive devices that can be selected from the light sensitive device array 102.

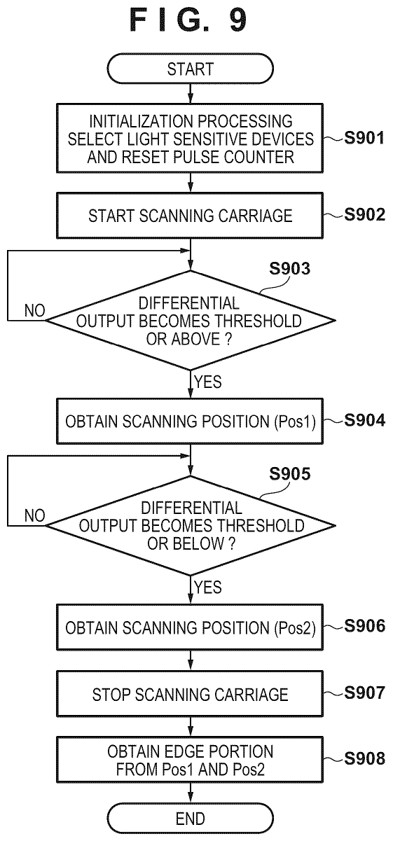

FIG. 9 is a flowchart for explaining processing for detecting an edge of a printing medium (sheet) in the inkjet printing apparatus according to the embodiment. The processing indicated in the flowchart is realized by the CPU 112 deploying a program stored in the ROM 112b into the RAM 112a and executing the program.

First, in step S901, the CPU 112 executes initialization processing. In the initialization processing, the selector 803 is set to select light sensitive devices 802 in the light sensitive device array 801 used to detect an edge. The pulse counter 118 for detecting the scanning position of the carriage 201 is reset. Next, the processing proceeds to step S902, and the CPU 112 starts scanning the carriage 201 by rotationally driving the motor 115. Next, the processing proceeds to step S903, and the CPU 112 determines whether the output of the differential amplifier 104 inputted to the digital input unit 107 has become the threshold or above. Unless the output of the differential amplifier 104 is the threshold or above, processing in step S903 is repeatedly executed, and when the output of the differential amplifier 104 becomes the threshold or above, the processing proceeds to step S904, and the CPU 112 detects the scanning position (Pos1) of the carriage 201 at that time based on the value of the pulse counter 118. Next, the processing proceeds to step S905, and the CPU 112 determines whether the output of the differential amplifier 104 has become the threshold or below while scanning the carriage 201. Unless the output of the differential amplifier 104 is the threshold or below, processing in step S905 is repeatedly executed, and when the output of the differential amplifier 104 becomes the threshold or below, the processing proceeds to step S906, and the CPU 112 detects the scanning position (Pos2) of the carriage 201 at that time based on the value of the pulse counter 118. Then, the processing proceeds to step S907, and the CPU 112 stops scanning the carriage 201 and proceeds to step S908. In step S908, the CPU 112 determines an edge portion of the sheet 202 based on the scanning positions (Pos1 and Pos2) as described above with reference to FIG. 4 and ends the processing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-128079, which was filed on Aug. 2, 2024 and which is hereby incorporated by reference herein in its entirety.

What is claimed is:

1. A printing apparatus comprising:
a sensor unit that includes a light emitter configured to emit light toward a detection target, a plurality of light sensitive units that include a first light sensitive unit and a second light sensitive unit configured to detect reflected light of the light, and an aperture member that is provided between the plurality of light sensitive units and the detection target and includes an opening configured to limit input of reflected light to a light sensitive unit; and
one or more controllers including one or more processors and one or more memories, wherein the one or more controllers are configured to:
cause the sensor unit to scan relative to the detection target; and
based on a differential signal obtained by differentially amplifying signals from the first light sensitive unit and the second light sensitive unit, detect an edge of a printing medium included in the detection target,
wherein the plurality of light sensitive units are arranged to be aligned in a scanning direction of the scan, and
the first light sensitive unit and the second light sensitive unit detect the reflected light through the same opening of the aperture member.

2. The printing apparatus according to claim 1, wherein the plurality of light sensitive units include a plurality of light sensitive devices, the first light sensitive unit includes one, two, or more light sensitive devices among the plurality of light sensitive devices, and the second light sensitive unit includes one, two, or more light sensitive devices different from the first light sensitive unit.

3. The printing apparatus according to claim 2, wherein a predetermined number of light sensitive devices are included between the first light sensitive unit and the second light sensitive unit.

4. The printing apparatus according to claim 2, wherein the one or more controllers are further configured to:
select, from the plurality of light sensitive devices, one, two, or more light sensitive devices to be the first light sensitive unit and one, two, or more light sensitive devices to be the second light sensitive unit.

5. The printing apparatus according to claim 4, wherein in the selection of the light sensitive devices, the one or more controllers select a light sensitive device such that a first detection region, in which the first light sensitive unit detects reflected light inputted through the same opening, and a second detection region, in which the second light sensitive unit detects reflected light inputted through the same opening, do not overlap.

6. The printing apparatus according to claim 1, wherein the aperture member and the same opening are arranged such that a first detection region, in which the first light sensitive unit detects reflected light inputted through the same opening, and a second detection region, in which the second light sensitive unit detects reflected light inputted through the same opening, do not overlap.

7. The printing apparatus according to claim 4, wherein in the selection of the light sensitive devices, the one or more controllers select one, two, or more light sensitive devices to be the first light sensitive unit and one, two, or more light sensitive devices to be the second light sensitive unit, based on a distance between the plurality of light sensitive units and the aperture member, a size of the same opening, and a distance between the aperture member and the detection target.

8. The printing apparatus according to claim 1, wherein a lateral surface of the same opening has a tapered shape that is wide on a side of the plurality of light sensitive units and narrow on a side of the detection target.

9. The printing apparatus according to claim 1, wherein the one or more controllers are further configured to:
obtain a scanning position of the sensor unit, which is caused to scan, and
in the detection of the edge of the printing medium, the one or more controllers
use a differential amplification unit configured to take input of a first signal, which is outputted from the first light sensitive unit, and a second signal, which is outputted from the second light sensitive unit, and output a differential signal,
and in the scanning of the sensor unit, detect the edge of the printing medium, based on first coordinates, which indicate a scanning position of the sensor unit when the differential signal is a threshold or above, and second coordinates, which indicate a scanning position of the sensor unit when the differential signal is the threshold or below.

10. The printing apparatus according to claim 9, wherein in the detection of the edge of the printing medium, the one or more controllers detect center coordinates between the first coordinates and the second coordinates as the edge of the printing medium.

11. The printing apparatus according to claim 1, wherein the detection target includes at least one of the printing medium and a platen that supports the printing medium.

12. The printing apparatus according to claim 1, wherein the light emitter emits light toward the detection target through an opening different from the same opening of the aperture member.
